(19) United States
(12) Patent Application Publication
(10) Pub. No.: US 2008/0192010 A1
(43) Pub. Date: Aug. 14, 2008

(54) TILT WHEEL TYPE MOUSE

(75) Inventor: Chih-Hung Lin, Taipei (TW)

Correspondence Address: KIRTON AND MCCONKIE, 60 EAST SOUTH TEMPLE,, SUITE 1800, SALT LAKE CITY, UT, 84111, US

(73) Assignee: PRIMAX ELECTRONICS LTD., Taipei (TW)

(21) Appl. No.: 11/757,469

(22) Filed: Jun. 4, 2007

(30) Foreign Application Priority Data
Feb. 9, 2007 (TW) 096104718

(51) Int. Cl. G06F 3/033

(52) U.S. Cl. 345/163

(57) ABSTRACT

The present invention relates to a tilt wheel type mouse. The tilt wheel type mouse includes a tiltable scroll wheel, a switch button and a switching program. Under execution of the switching program, a frame shown on a computer screen is backward to the previous page or forward to the next page when the scroll wheel is rotated in the left or right direction.

### FIELD OF THE INVENTION

The present invention relates to a mouse, and more particularly to a tilt wheel type mouse.

### BACKGROUND OF THE INVENTION

A mouse device is an important bridge between a computer system and a user. In addition to the basic functions of controlling cursor movement, the mouse device is developed to execute extended functions.

For example, by rotating a scroll wheel of the mouse device forwardly or backwardly, a specified control signal is generated to control the scrolling operations of web pages. In addition to the vertical scroll movement, it is important to achieve the horizontal scroll movement. Since the texts or graphs shown in the graphic-based window of the display screen usually fail to be fully browsed, the horizontal scroll movement is required to move the web page or document in the left or right direction so as to display the desired image. Since the scroll wheel assembly of a conventional mouse device permits for single axial rotation, the image shown on the screen of the computer system may be vertically scrolled. For horizontally moving the web page or document shown on the screen by operating the scroll wheel, the left click button of the mouse device should be continuously pressed down and tilted in the horizontal direction. Since the single axial rotation of the mouse device is unsatisfactory for horizontal scroll movement, a tilt wheel assembly is developed for controlling horizontal scroll movement of the image shown on the computer screen.

Referring to FIG. 1, a schematic perspective view of a conventional tilt wheel type mouse 10 is illustrated. The tilt wheel type mouse 10 includes a tilt wheel assembly 11. The tilt wheel assembly 11 of the mouse 10 can be rotated in a first axial direction 12 to have the image shown on the computer screen move upwardly and downwardly (i.e. in the vertical direction). Moreover, the tilt wheel assembly 11 of the mouse 10 can be tilted in a second axial direction 13 to have the image shown on the computer screen move leftwards or rightwards (i.e. in the horizontal direction). In comparison with the scroll wheel assembly, the tilt wheel assembly 11 is more convenient for browsing documents or web pages.

Nowadays, with increasing development of computer technologies, the computer screen is developed toward increasing resolution and thus the width of the image may be fully shown on the computer screen. Under this circumstance, the utilization of the second axial direction 13 is largely reduced. Recently, since Internet has gained popularity, the computer system is frequently operated with Internet Explorer (IE) software to browse web pages. As known, in browsing the web pages, the “Previous Page” and “Next Page” functions are frequently used. Typically, the “Previous Page” and “Next Page” functions are executed by either clicking the “Backward” and “Forward” icons on the option menu of the graphic-based window or clicking composite hotkeys (e.g. “ALT+Left” and “ALT+Right”) on the keyboard. The approach of selecting the items on the option menu and the approach of clicking hotkeys on the keyboard are not user-friendly. Moreover, when the computer system is operated in the Windows environment, the function of switching windows is executed by clicking the “Frame” items on the option menu and then selecting a desired frame. This approach of changing windows is also inconvenient.

In views of the above-described disadvantages resulted from the prior art, the applicant keeps on carving unflaggingly to develop a tilt wheel type mouse according to the present invention through wholehearted experience and research.

### SUMMARY OF THE INVENTION

It is an object of the present invention to provide a tilt wheel type mouse having a built-in switching program, so that the “Backward” and “Forward” functions are executable when the scroll wheel is tilted in the left/right directions.

In accordance with an aspect of the present invention, there is provided a tilt wheel type mouse for use with a computer. The tilt wheel type mouse includes a scroll wheel, a switch button and a switching program. The scroll wheel may control vertical scrolling movement of an image shown on a computer screen when the scroll wheel is rotated in a first-axial direction, and control horizontal scrolling movement of the image shown on the computer screen when the scroll wheel is tilted in a second-axial direction. The switch button is actuated to generate a triggering signal. The switching program is activated in response to the triggering signal. Under execution of the switching program, a frame shown on the computer screen is backward to the previous page or forward to the next page when the scroll wheel is rotated in the second-axial direction.

In an embodiment, the frame is backward to the previous page when the scroll wheel is tilted toward the left direction, and the frame is forward to the next page when the scroll wheel is tilted toward the right direction.

In an embodiment, the frame is forward to the next page when the scroll wheel is tilted toward the left direction, and the frame is backward to the previous page when the scroll wheel is tilted toward the right direction.

In accordance with another aspect of the present invention, there is provided a wheel function switching method of a tilt wheel type mouse. The tilt wheel type mouse includes a scroll wheel, a switch button and a switching program. The scroll wheel is rotated in a first-axial direction to control vertical scrolling movement of an image shown on a computer screen and tilted in a second-axial direction to control horizontal scrolling movement of the image shown on the computer screen. The wheel function switching method including steps of actuating the switch button to generate a triggering signal and activating the switching program in response to the triggering signal, wherein under execution of the switching program, a frame shown on the computer screen is backward to the previous page or forward to the next page when the scroll wheel is rotated in the second-axial direction.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic perspective view of a conventional tilt wheel type mouse;

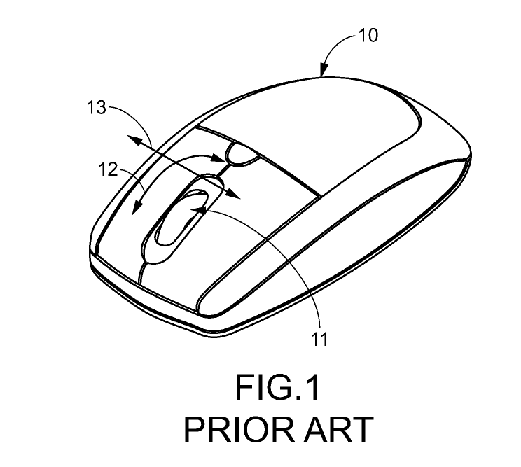

FIG. 2 is a schematic view of a tilt wheel type mouse according to a preferred embodiment of the present invention; and

FIG. 3 is a flowchart illustrating a wheel function switching method implemented by the tilt wheel type mouse of the present invention.

### DETAILED DESCRIPTION OF THE PREFERRED EMBODIMENT

For overcoming the above described drawbacks resulting from the conventional tilt wheel type mouse, the present invention relates to an improved tilt wheel type mouse having a built-in switching program.

As previously described, the probability of controlling horizontal scroll movement of images shown on the computer screen is gradually reduced. Even if the function of controlling horizontal scroll movement of images shown on the computer screen is occasional, the operation of the second axial direction is rather reserved. Moreover, as previously described, the “Backward” and “Forward” functions are frequently used, but the approaches of executing these functions are neither convenient nor user-friendly. As a consequence, according to concept of the present invention, the approach of executing the “Backward” and “Forward” functions is improved by utilizing the second-axial tilting operation.

In accordance with a feature of the present invention, the tilt wheel type mouse has a built-in switching program. Under execution of the switching program, in response to the second-axial leftward and rightward tilting operations, the “Page up” and “Page down” functions are enabled but the function of controlling horizontal scroll movement is disabled. That is, the horizontal scrolling function is switched to the Backward/Forward functions at that moment. In addition, the switching program is stored in a circuit board of the tilt wheel type mouse. The mouse has a switch button, which is triggered to activate the switching program.

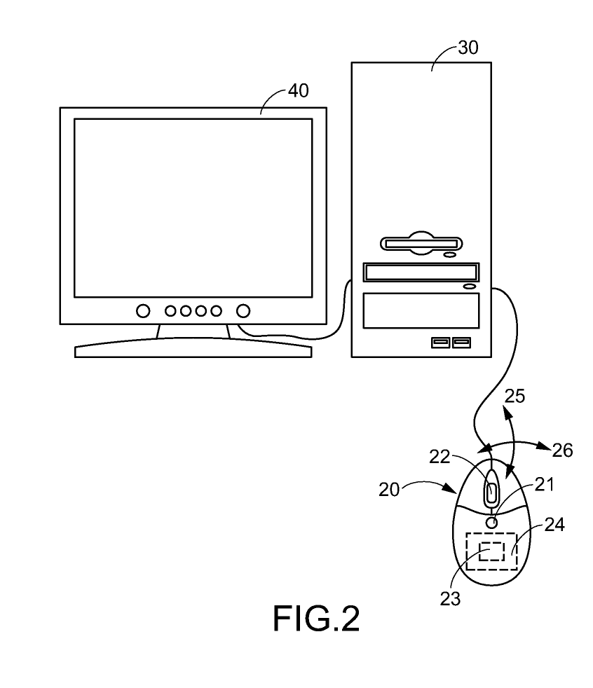

Referring to FIG. 2, a schematic view of a tilt wheel type mouse according to a preferred embodiment of the present invention is illustrated. The tilt wheel type mouse 20 of FIG. 2 is communicated with a host computer 30, which is also electrically connected to a computer screen 40. The tilt wheel type mouse 20 principally includes a switch button 21 and a scroll wheel 22. The scroll wheel 22 may be rotated in a first axial direction 27 and tilted in a second axial direction 26. In addition, a circuit board 24 is disposed within the main body of the tilt wheel type mouse 20. A switching program 23 is stored in the circuit board 24. Originally, when the scroll wheel 22 is tilted in the second axial direction 26, i.e. in the left/right direction, the images shown on the computer screen 40 will move leftwards/rightwards. In this embodiment, when the scroll wheel 22 is rotated in the first axial direction 25, the image shown on the computer screen is move in the vertical direction, as is identical to the conventional technology. Specifically, once the switch button 21 is pressed down, a triggering signal is generated and transmitted to the circuit board 24. In response to the triggering signal, the switching program 23 is activated. Under execution of the switching program 23, the second-axial tilting operation of the scroll wheel 22 is switched from a horizontal scroll controlling mode to a page-changing mode. In this page-changing mode mode, when the scroll wheel 22 is tilted in the left direction, the host computer 30 may execute a “Backward” function such that the frame shown on the computer screen 40 is backward to the previous page. Whereas, when the scroll wheel 22 is tilted in the right direction, the host computer 30 may execute a “Forward” function such that the frame shown on the computer screen 40 is forward to the next page. Once the switch button 21 is pressed down again, the second-axial tilting operation of the scroll wheel 22 is switched from the page-changing mode to the original horizontal scroll controlling mode.

A further embodiment of a tilt wheel type mouse is illustrated as follows. The components included therein are similar to those shown in FIG. 2, and are not redundantly described herein. Likewise, once the switch button 21 is pressed down to activate the switching program 23, the second-axial tilting operation of the scroll wheel 22 is switched from the horizontal scroll controlling mode to the page-changing mode. In this embodiment, however, when the scroll wheel 22 is tilted in the left direction, the host computer 30 may execute a “Forward” function such that the frame shown on the computer screen 40 is forward to the next page. Whereas, when the scroll wheel 22 is tilted in the right direction, the host computer 30 may execute a “Backward” function such that the frame shown on the computer screen 40 is backward to the previous page. Once the switch button 21 is pressed down again, the second-axial tilting operation of the scroll wheel 22 is switched from the page-changing mode to the original horizontal scroll controlling mode.

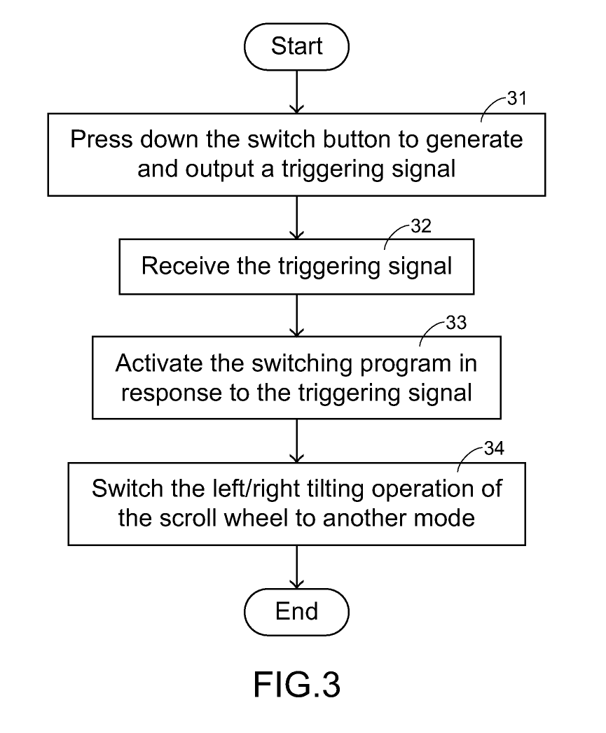

Hereinafter, a wheel function switching method will be illustrated with reference to the flowchart of FIG. 3.

First of all, when the switch button is pressed down, a triggering signal is generated and outputted (Step 31). After the triggering signal is received (Step 32), in response to the triggering signal, the switching program is activated (Step 33). Under execution of the switching program, the second-axial tilting operation of the scroll wheel is switched to another mode (Step 34).

From the above description, the tilt wheel type mouse of the present invention can be operated between a horizontal scroll controlling mode and a page-changing mode. Although the function of controlling horizontal scroll movement of images shown on the computer screen is occasionally used, the second-axial tilting operation of the scroll wheel is reserved. By means of the switching program, the “Backward” and “Forward” functions are executed when the scroll wheel is tilted in the second-axial direction. As a consequence, the second-axial tilting operation of the scroll wheel may be switched according to the user's requirement. If appropriate, the complicated approaches of selecting the items on the option menu and clicking hotkeys on the keyboard may be exempted. Moreover, since the scroll wheel is arranged between the left click button and the right click button of the mouse, the tilt wheel type mouse of the present invention may comply with the requirement of right-hand users and the left-hand user because it is very easy-to-use.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A tilt wheel type mouse for use with a computer, said tilt wheel type mouse comprising:
a scroll wheel for controlling vertical scrolling movement of an image shown on a computer screen when said scroll wheel is rotated in a first-axial direction, and controlling horizontal scrolling movement of said image shown on said computer screen when said scroll wheel is tilted in a second-axial direction;
a switch button actuated to generate a triggering signal; and
a switching program activated in response to said triggering signal, wherein under execution of said switching program, a frame shown on said computer screen is backward to the previous page or forward to the next page when said scroll wheel is rotated in said second-axial direction.

2. The tilt wheel type mouse according to claim 1 wherein said frame is backward to the previous page when said scroll wheel is tilted toward the left direction, and said frame is forward to the next page when said scroll wheel is tilted toward the right direction.

3. The tilt wheel type mouse according to claim 1 wherein said frame is forward to the next page when said scroll wheel is tilted toward the left direction, and said frame is backward to the previous page when said scroll wheel is tilted toward the right direction.

4. A wheel function switching method of a tilt wheel type mouse, said tilt wheel type mouse including a scroll wheel, a switch button and a switching program, said scroll wheel being rotated in a first-axial direction to control vertical scrolling movement of an image shown on a computer screen and tilted in a second-axial direction to control horizontal scrolling movement of said image shown on said computer screen, said wheel function switching method including steps of:
actuating said switch button to generate a triggering signal; and
activating said switching program in response to said triggering signal, wherein under execution of said switching program, a frame shown on said computer screen is backward to the previous page or forward to the next page when said scroll wheel is rotated in said second-axial direction.
